(19) United States
(12) Patent Application Publication
(10) Pub. No.: US 2014/0081721 A1
(43) Pub. Date: Mar. 20, 2014

(54) SERVING OFFERS WITHIN APPLICATIONS RUNNING ON MOBILE DEVICES

(71) Applicant: Yoav Yaari, San Francisco, CA (US)

(72) Inventor: Yoav Yaari, San Francisco, CA (US)

(21) Appl. No.: 13/616,413

(22) Filed: Sep. 14, 2012

(51) Int. Cl. G06Q 30/02

(52) U.S. Cl. 705/14.12; 705/14.15

(57) ABSTRACT

From within an application other than a web browser running on a mobile device: a user is presented with the opportunity to receive a benefit and payment options for the benefit. The payment options includes offers, where completing any of the collection of offers entitles the user to receive the benefit. The collection of offers is loaded from a source outside the mobile device. An indication of interest in a selected offer is received, and the user is presented with first content describing the selected offer in a first collapsible pane. Simultaneously with presenting the first content, the user is presented with second content describing the selected offer in a second collapsible pane. Information sufficient to complete the selected offer is received and sent to an offer platform. A notification that the selected offer has been completed is received from the platform, the benefit is provided to the user.

### TECHNICAL FIELD

This document relates to serving offers within applications running on mobile devices.

### BACKGROUND

Offer platforms enable users to get items of interest at a discount or for free. Offers from offer platforms can be served to users in a variety of media, including through a web browser or in other online applications. Offers can also be served to users on a mobile device.

### SUMMARY

In general, in one aspect, serving offers on a mobile device includes, from within an application other than a web browser running on a mobile device: presenting a user with the opportunity to receive a benefit, and presenting the user with payment options for the benefit. The payment options including a collection of offers, where completing any of the collection of offers entitles the user to receive the benefit. The collection of offers is loaded from a source outside the mobile device. An indication of interest in a selected offer is received, and the user is presented with first content describing the selected offer in a first collapsible pane. Simultaneously with presenting the first content, the user is presented with second content describing the selected offer in a second collapsible pane. Information sufficient to complete the selected offer is received and sent to an offer platform. A notification that the selected offer has been completed is received from the platform, the benefit is provided to the user.

Implementations may include one or more of the following features: The application includes a game, and the benefit includes virtual currency usable in the game. The application includes a free version of a product, and the benefit includes a premium version of the product. The first content includes terms and conditions of the offer. The second offer includes a description of an item of the offer. The first and second collapsible panes are presented by invoking a webView instance. The collection of offers is initially presented in the first or second collapsible pane.

Other aspects include other combinations of the features recited above and other features, expressed as methods, apparatus, systems, devices, program products, and in other ways. Other features and advantages will be apparent from the description and from the claims.

### DESCRIPTION OF DRAWINGS

Embodiments of the invention described herein may be understood by reference to the following figures, which are provided by way of example and not of limitation:

FIG. 1 is a schematic depiction of a conventional offer platform

FIG. 2 is a schematic depiction of conventionally serving offers on a mobile device

FIG. 3 is a schematic depiction of serving offers on a mobile device

FIG. 4 is block diagram of an offer-enabled application architecture.

FIG. 5 is a flowchart for serving offers on a mobile device.

Like references numbers refer to like structures.

### DETAILED DESCRIPTION

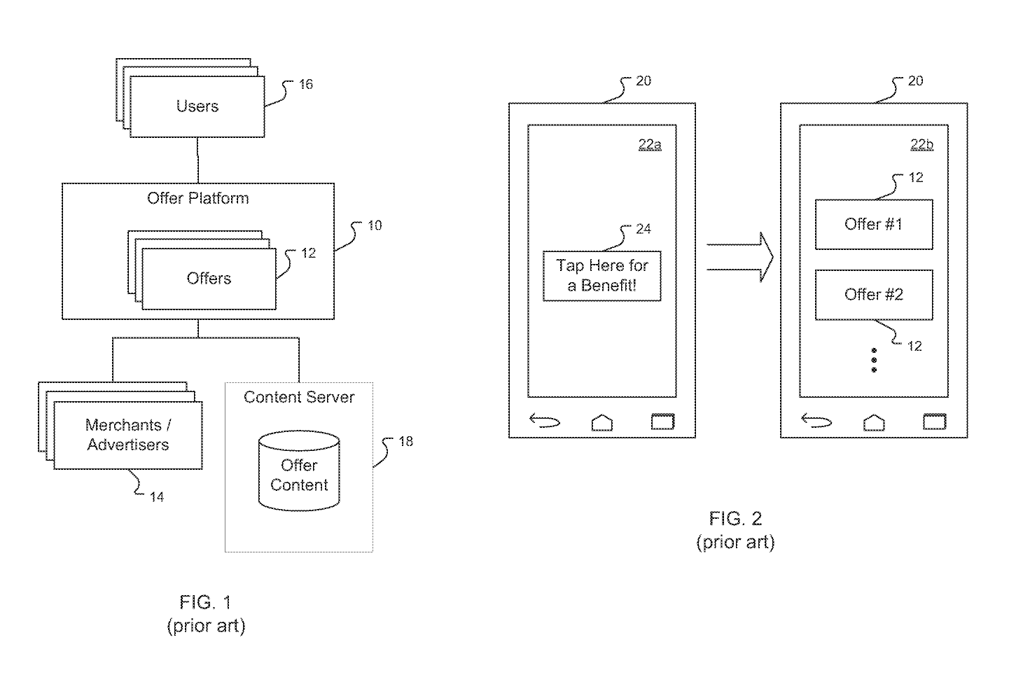

FIG. 1 is a schematic depiction of a conventional offer platform. The offer platform 10 includes information about offers 12 to buy one or more products or services from a merchant 14, and consequently obtain an additional benefit beyond the products or services purchased. The offer platform 10 typically works by presenting a user 16 with such an offer 12 at a moment when the user is interested in obtaining the additional benefit.

For example, suppose a user 16 is viewing the purchase page of a mobile application whose retail price is $5. The offer platform 10 may present the user with an offer 12, via the purchase page, to buy a $20 gift card to a particular restaurant and consequently get the mobile application for free. In this example, the restaurant is the merchant, and the benefit is the $5 mobile application.

Often, the merchant will partially or entirely bear the cost of providing the benefit. Thus, in the example above, the restaurant may pay $5 to the seller of the mobile application, and is essentially offering a $20 restaurant gift card for $15. Insofar as the user may not have otherwise purchased the gift card, the restaurant may consider the $5 cost as an advertising expenditure. For this reason, merchants 14 are equivalently referred to as advertisers.

As used above, an offer 12 refers to the information pertinent to serving that particular offer to a user 16. For example, such information will include the product or service, its price, target demographic, etc. This is to be distinguished from offer content, which is refers to the text, graphics, audio, video, executable code, or other material that is viewed by the user 16. Offer content typically resides on a content server 18, where it may be customized and updated as necessary by the merchants. The content server 18 may be part of the offer platform 10, or may be part of a merchant's electronic infrastructure, or may be part of a third party storage facility, or a combination of these. In general, the content of different offers 12 may be stored on different content servers 18.

Further details of particular offer platforms can be found in U.S. Pat. No. 7,848,960, entitled “Methods for an Alternative Payment Platform,” assigned on its face to TrialPay, Inc., the entirety of which is incorporated by reference herein. Offers are served in many ways. For example, U.S. patent application Ser. No. 13/027,819, entitled “Dynamically Serving Content to Social Network Members,” assigned on its face to TrialPay Inc., and incorporated by reference herein, describes serving offers in various ways to social network users.

These techniques face particular challenges in the context of mobile devices. Mobile devices often have relatively small screen size, and mobile operating systems often do not allow more than one application to be viewable at once. Thus, sometimes a user must switch applications to complete an offer.

FIG. 2 is a schematic depiction of conventionally serving and completing offers on a mobile device. For example, FIG. 2 may depict some implementations of the techniques described above. Initially, a user of a mobile device 20 is presented with an icon 24 to obtain a benefit, in the context of a first application 22a. For example, the first application may be a game, and the benefit may be a certain amount of virtual currency to be used in the game. In another example, the first application may be a free version of a mobile application, and the benefit may be the premium version. More generally, for any first application, the benefit may include some upgrade, enhancement, or capability pertinent to the first program. However, the benefit need not relate to the first application at all. For example, the first application may involve a social game, and the benefit may involve a magazine subscription. When the user taps the icon 24, he is taken to a second application 22b (a web browser). Here, he is presented with various offers 12 that, if completed, would entitle him to receive the benefit.

However, mobile device users often hesitate or have a preference against switching from one application to another. The process can be relatively slow, for example if the mobile device must activate its native web browser. This is especially true in some situations in which a mobile device user only intends to use his device for a relatively short period of time, e.g., standing in line at a store, waiting for a friend, etc. In these cases (or others), even a short delay associated with switching applications may be uncomfortable. Additionally, some users are more accustomed to using a web browser on a standard personal computer, and simply find mobile web browsers uncomfortable to use as a matter of personal preference.

Furthermore, for some mobile applications 22a, there is a risk that when the user returns to the application from the web browser, the application will be in a different, less desirable state. For example, if the application 22a is a game, the user may return to the game and lose a certain amount of game progress.

Finally, sometimes a user may desire to return to the application 22a for additional information to decide which offer 12 to complete. For example, if the different offers 12 each provide different amounts of virtual currency in a game 22a, the user may need to return to the game 22a to determine how much virtual currency he needs to complete a particular in-game task. Subsequently, the user much again switch back to the browser 22b a second time to complete the appropriate offer, thus further exacerbating the disadvantages associated with switching applications.

The techniques below allow an offer platform 10 to serve offers 12 within an application 22 (different from a web browser) running on a mobile device 20, such that users 16 may select and satisfy offers within the application 22.

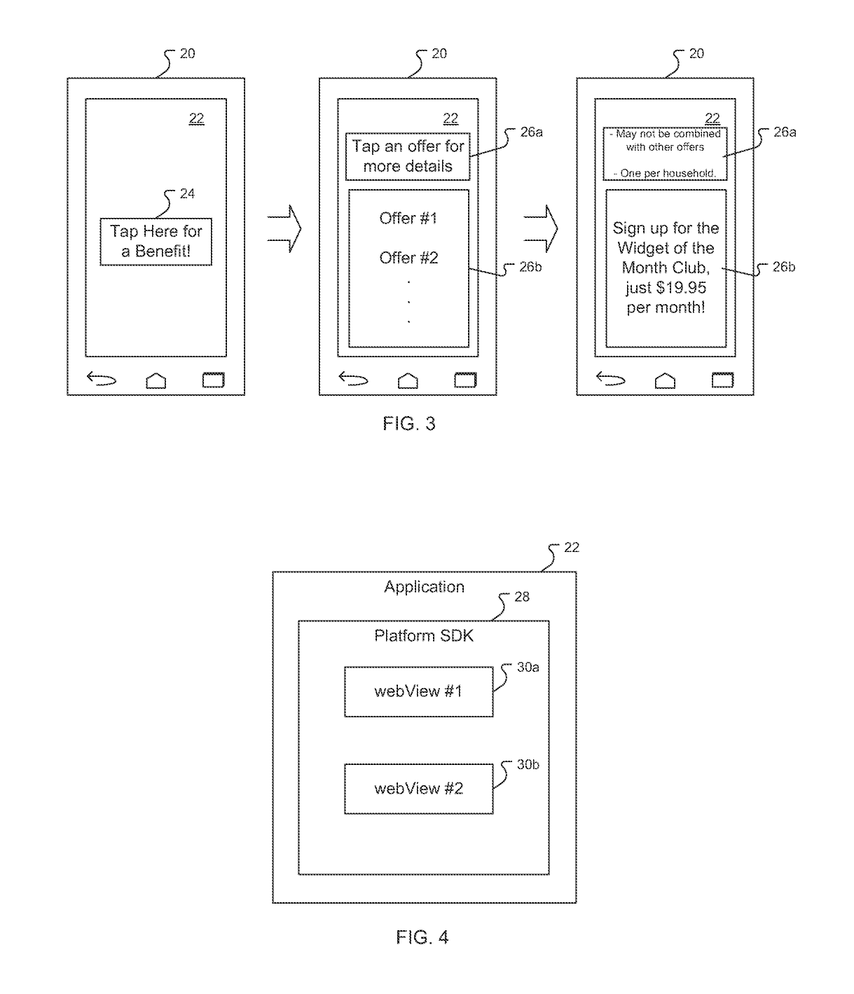

FIG. 3 is a schematic depiction of serving and completing offers on a mobile device. Initially, the mobile device 20 is running a particular application 22, such as a game. It is assumed the application 22 is not a web browser, but in general may be any other application. Within the application 22, an icon 24 appears alerting the user of the mobile device 20 that a benefit is available. In some implementations, the icon 24 includes a brief description of the benefit, such as “earn virtual currency” or “get free food at local restaurants.”

When the user taps the icon 24, two panes 26a, 26b are opened within the application 22. The panes 26a, 26b display offer content associated with presenting and completing the various offers available to the user at that time. Although reference is made to two panes 26a, 26b in this document, in principal any number of panes 26 may be used.

In some implementations, the initial content in pane 26a invites the user to select an offer from those listed in pane 26b for more details. The content in pane 26b lists a summary or brief description of a collection of available offers. As the user clicks on the brief description of an offer, the terms and conditions (or other text-based content) of the corresponding offer are loaded into pane 26a, while content further describing the product or service of the offer (e.g., content touting its desirability) is loaded into pane 26b.

In some implementations, the panes 26a, 26b are collapsible. Thus, a user can focus on reading the content in either of the respective panes, which can be advantageous particularly on mobile devices with small displays.

In some implementations, one of the panes 26a, 26b includes a control for the user to complete the offer. Upon activating this control, the user is then presented with a screen in one of the panes 26a, 26b in which he can enter the required information (e.g., credit card number, billing address, shipping address, etc.). After completing the offer, the user may be returned to the point in the application 22 he was in prior to clicking the icon 24. Advantageously, throughout this process, the user does not exit the application 22.

FIG. 4 is a block diagram of an offer-enabled application architecture. This architecture can be used to implement the techniques described in this document. To allow offers 12 to be served within an application 22 from the offer platform 10, the developer of the application 22 includes a Software Development Kit (“SDK”) or similar code package into the application. In some implementations, the offer platform 10 makes the SDK available from an easily-accessed location (e.g., a web page, code repository, etc.) to facilitate partnerships between application developers and the offer platform.

In some implementations, for example where the mobile device 20 is running the Android™ operating system, the SDK implements the two panes 26a, 26b as webView instances. Each webView instance may then communicate with the offer platform 10 and/or various content servers 18 in traditional ways (e.g., Java, Javascript, AJAX, etc.), to display appropriate content to the user and send user input to the offer platform 10. Similar classes to webView are available for operating systems other than Android™, and one of ordinary skill in the art will recognize whichever suitable modifications may be necessary to implement these techniques in other operating systems.

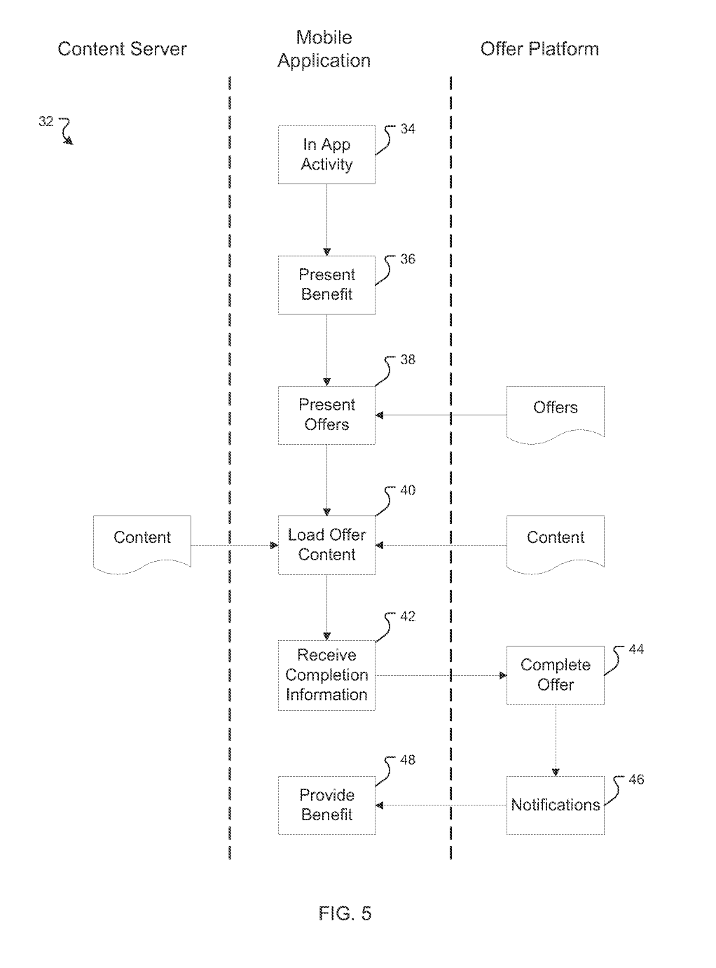

FIG. 5 is a flowchart for serving offers on a mobile device. The process 32 begins with the user performing some normal or pre-determined activity within a mobile application different from a web browser (step 34). The application then presents an opportunity for a benefit (step 36). In some implementations, the opportunity can be presented in the form of an icon 24.

If the user indicates interest in obtaining the benefit (e.g., by tapping the icon 24), then a collection of offers are presented (step 38), and the user is informed that completing any of the offer will entitle him to receive the corresponding benefit. In some implementations, the offers may be presented along with other conventional payment options to receive the benefit, such as payment by credit card, debit card, or the like. In some implementations, the collection of offers is presented in a manner consistent with that shown in FIGS. 3 and 4; that is, the offers and other relevant information is presented in collapsible panes (e.g., by invoking a webView instance).

When the user indicates interest in a particular offer (e.g., by tapping on the offer's icon), then the full offer content is loaded (step 40). The content may be loaded from the offer platform itself, from a separate content server, or some other location (e.g., locally on the mobile device). If the decides to complete the offer, he enters information sufficient to do so (e.g., credit card number, billing address, customer loyalty or bonus program account number, etc.) (step 42).

This information is then sent to the offer platform, which subsequently completes the offer (step 44). In some implementations, completing the offer includes debiting or crediting accounts of the user, the merchant, or other parties associated with the transaction, or other such steps are required by the merchant and/or user for that particular offer.

Once the offer is completed, notifications of are sent to the parties involved (step 46). In some implementations, the notifications include a confirmation of offer completion to the application 22. In some implementations, notifications can include confirmation to other parties involved, such as the user, the merchant, etc. Such confirmation can include information relevant to tracking and analytics, such as the price paid by the user, the method by which the user paid (e.g., which credit card was used, etc.), the revenue to the merchant, a transaction fee to the offer platform, a transaction ID for the particular transaction, a timestamp, demographic information about the user, a current location of the mobile device, information about the mobile device hardware and/or software (e.g., device make and model, operating system, specifications, etc.), or other such pre-determined information considered relevant by the merchant, offer platform, or other party.

In step 48, the benefit is provided to the user (step 48). Although this step is shown in FIG. 5 as taking place on the mobile device, in general providing the benefit may involve the cooperation of several parties. For example, the benefit may include software to be downloaded from a merchant server (or other location), the benefit may include a physical item to be shipped to the user, the benefit may require the user being in a particular location at a particular time, etc. Thus, “providing the benefit” as implemented on the mobile device should be understood to include informing the user that the benefit is available, and what steps (if any) the user must do to obtain it.

While the foregoing drawings and description set forth functional aspects of the disclosed systems, no particular arrangement of software and/or hardware for implementing these functional aspects should be inferred from these descriptions unless explicitly stated or otherwise clear from the context, and all such arrangements of software and/or hardware are intended to fall within the scope of this disclosure.

Many of the above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In embodiments, disclosed herein are computer program products comprising computer-executable code or computer-usable code that, when executing on one or more computing devices (such as the devices/systems described above), performs any and/or all of the steps described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the invention(s) described herein are intended to include any suitable method of causing one or more other parties or entities to perform the steps consistent with the patentability of the following claims, unless a different meaning is expressly provided or otherwise clear from the context. Such parties or entities need not be under the direction or control of any other party or entity, and need not be located within a particular jurisdiction. Thus for example, a description or recitation of “adding a first number to a second number” includes causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed.

While the invention has been disclosed in connection with certain embodiments, other embodiments are possible and will be recognized by those of ordinary skill in the art. All such variations, modifications, and substitutions are intended to fall within the scope of this disclosure. Thus, the invention is to be understood with reference to the following claims.

1. A method for serving offers on a mobile device, comprising:
from within an application other than a web browser running on a mobile device:
presenting a user with the opportunity to receive a benefit;
presenting the user with payment options for the benefit, the payment options including a collection of offers, wherein:
completing any of the collection of offers entitles the user to receive the benefit, and
the collection of offers is loaded from a source outside the mobile device;
receiving an indication of interest in a selected offer;
presenting the user with first content describing the selected offer in a first collapsible pane;
simultaneously with presenting the first content, presenting the user with second content describing the selected offer in a second collapsible pane;
receiving information sufficient to complete the selected offer and sending the information to an offer platform;
receiving a notification that the selected offer has been completed; and
providing the benefit to the user in the application.

2. The method of claim 1, wherein the application includes a game, and the benefit includes virtual currency usable in the game.

3. The method of claim 1, wherein the application includes a free version of a product, and the benefit includes a premium version of the product.

4. The method of claim 1, wherein the first content includes terms and conditions of the offer.

5. (canceled)

6. The method of claim 1, wherein the first and second collapsible panes are presented by invoking a webView instance.

7. The method of claim 1, wherein the collection of offers is initially presented in the first or second collapsible pane.

8. A mobile device comprising:
a processor;
memory bearing instructions that, when executed, cause the processor to launch an application other than a web browser, and from within the application:
present a user with the opportunity to receive a benefit;
present the user with payment options for the benefit, the payment options including a collection of offers, wherein:
completing any of the collection of offers entitles the user to receive the benefit, and
the collection of offers is loaded from a source outside the mobile device;
receive an indication of interest in a selected offer;
present the user with first content describing the selected offer in a first collapsible pane;
simultaneously with presenting the first content, present the user with second content describing the selected offer in a second collapsible pane;
receive information sufficient to complete the selected offer and sending the information to an offer platform;
receive a notification that the selected offer has been completed; and
provide the benefit to the user in the application.

9. The mobile device of claim 8, wherein the application includes a game, and the benefit includes virtual currency usable in the game.

10. The mobile device of claim 8, wherein the application includes a free version of a product, and the benefit includes a premium version of the product.

11. The mobile device of claim 8, wherein the first content includes terms and conditions of the offer.

12. (canceled)

13. The mobile device of claim 8, wherein the first and second collapsible panes are presented by invoking a webView instance.

14. The mobile device of claim 8, wherein the collection of offers is initially presented in the first or second collapsible pane.
